(19) United States
(12) Patent Application Publication
(10) Pub. No.: US 2016/0173527 A1
(43) Pub. Date: Jun. 16, 2016

(54) METHOD AND SYSTEM FOR PROTECTING AGAINST MOBILE DISTRIBUTED DENIAL OF SERVICE ATTACKS

(71) Applicant: NXLabs Limited, Tortola (GB)

(72) Inventors: Juniman KASMAN, Hong Kong (HK); Hai ZHAO, Hong Kong (HK); Xiaohai LU, Hong Kong (HK); Mingfeng HUANG, Hong Kong (HK); Yu GUO, Hong Kong (HK); Ryan CHIN, Hong Kong (HK)

(21) Appl. No.: 14/670,468

(22) Filed: Mar. 27, 2015

Related U.S. Application Data
(63) Continuation-in-part of application No. 14/565,440, filed on Dec. 10, 2014.

(51) Int. Cl. H04L 29/06

(52) U.S. Cl. CPC H04L 63/1458; H04L 63/1416

(57) ABSTRACT

A DDoS attack mitigation system implemented by a DDoS attack mitigation central processing server configured to execute server-side machine instructions and a mobile communication device configured to execute device-side machine instructions. The server-side machine instructions include: a reverse proxy traffic handler and a user-interactive DDoS attack mitigation scheme handler for issuing DDoS attack mitigation challenges and authenticating the users' authenticating actions. The device-side machine instructions are encapsulated in a SDK which includes a user-interactive DDoS attack mitigation scheme, and a set of APIs to facilitate the invocation calls from the mobile app integrating the DDoS attack mitigation system. The user-interactive DDoS attack mitigation scheme is a gesture-based CAPTCHA with a GUI suitable to be displayed on the mobile communication device's touch screen and accepts touch input. The user-interactive DDoS attack mitigation scheme essentially is a grid with finger touch movement path or pattern indicator connecting two or more vertices.

### CROSS-REFERENCES TO RELATED APPLICATIONS

This application is a continuation-in-part application of the U.S. patent application Ser. No. 14/565,440 filed Dec. 10, 2014, the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to systems and methods of protecting against distributed denial of service (DDoS) attacks in computing, electronic, mobile, and data communication networks. More particularly, the present invention relates to the use of Completely Automated Public Turing Test To tell Computers and Humans Apart (CAPTCHA), gesture-based CAPTCHA, and the like for mobile computing in protecting against DDoS attacks on Internet web sites, mobile network, and other network resources.

### BACKGROUND

A distributed denial of service (DDoS) attack is an attempt to make a computer server device or network resource unavailable to its intended users. A common form of DDoS attack is to use one or more computing devices running self-executing computer instructions (generally referred to as “bots”) to repeatedly send bogus data communication messages in heavy volume to a targeted computer server device or network resource. These bogus data communication messages often are to request for services from the targeted computer server device or network resource. The goal is to saturate the network bandwidth or computing capacity of the targeted computer server device or network resource in its attempt to provide the services requested in respond to the bogus data communication messages.

To defend a computer server device or network resource against DDoS attacks, in general the first task is to distinguish the bogus data communication messages from genuine legitimate data communication messages received. There are mainly two types of DDoS attack mitigation for this first task: 1.) user-transparent mitigation that causes no visual impact to and requires no interaction from a legitimate user of computing device or network resource, such as HTTP redirect which artificially redirects under the HTTP 302 protocol, webpage snippet insertion, and artificial webpage loading waits that discriminate only legitimate user's browser software application and not bots; and 2.) user-interactive mitigation that requires authenticating or acknowledgement action from the user, such as CAPTCHA.

However, there are serious shortcomings in both types of DDoS attack mitigation. For instance, under the user-interactive mitigation schemes, if the required user action is designed to be simple, then it can be easily circumvented by bots; otherwise if the required user action is designed to be too complex, then it can become user unfriendly. Another shortcoming is that the traditional DDoS attack mitigations are designed to work primarily with desktop or laptop computers running conventional Internet browser software applications.

With the rise of use of mobile communication devices, such as “smartphones” and tablet personal computers, computer server devices and network resources are increasing in need to be configured to communicate with these mobile communication devices running specifically designed mobile software applications (generally referred to as “apps”). Many mobile apps do not necessary conform to the Internet standard protocols such as HTTP and HTML, or understand the popular Internet scripting languages such as JavaScript, DHTML, and Ajax. Although some of these mobile apps are mobile versions of the conventional Internet browser software applications, due to the much smaller physical form factors and different user input interfaces of these mobile communication devices, traditional user interface designs, including those of existing DDoS attack mitigations, are poorly fit for these mobile versions Internet browser software applications. As such these DDoS attack mitigations perform poorly, if not entirely unsuitable, for computer server devices and network resources configured to communicate and interact with mobile apps.

One type of gesture-based CAPTCHA that maybe considered for use in mobile communication devices is an adaptation of touch gestures, which are finger movements detected by a mobile communication device's touch screen for user authentication and unlocking the locked mobile communication device. The U.S. Pat. No. 8,762,893 discloses a method of using user-defined touch gestures for various device and application controls. It further discloses that once a first touch gesture is defined by the user to represent a particular control, a second touch gesture, which is similar but not exactly the same as the first touch gesture, for example different orientation, can be recognized by the claimed method as to represent a related control. However, while such use for touch gesture maybe suitable for locking and unlocking or controlling a mobile communication device locally, it does not lead to a DDoS attack mitigation scheme, of which the primary purpose is to distinguish a guanine human user from a bot through a challenge and response.

Another challenge is that each Internet web site, mobile app, computer server device, or network resource looking to implement the defense mechanism against DDoS has few options but to build its own solution customized for its application. A customized solution may include the user interface elements for the user-interactive DDoS attack mitigation scheme that can be integrated with the application's user interface, the backend server processing module to process the challenge and response of the user-interactive DDoS attack mitigation scheme, and the network traffic data processing module to monitor and filter network data traffic for DDoS attacks. Such customized solution is expensive to build and maintain. Therefore, there is an unmet need to provide a more generalized solution that can be easily integrated with a wide range of applications including mobile apps.

### SUMMARY

It is an objective of the presently claimed invention to provide a method and system for protecting against DDoS attacks that can be used for computer server devices and network resources configured to communicate and interact with mobile communication devices running mobile apps. It is a further objective of the presently claimed invention to provide such method and system that incorporate an user-interactive type mitigation that is suitable for mobile communication devices with user friendly design. It is still a further objective of the presently claimed invention to provide such method and system that can be easily integrated with a wide range of applications including mobile apps.

In accordance with one aspect of the present invention, a DDoS attack mitigation system is provided and is implemented by a DDoS attack mitigation central processing server configured to execute server-side machine instructions and a mobile communication device having one or more computer processors configured to execute device-side machine instructions. The server-side machine instructions can be logically grouped into functional modules including: a reverse proxy traffic handler and a user-interactive DDoS attack mitigation scheme handler for issuing DDoS attack mitigation challenges and authenticating the users' authenticating actions. The device-side machine instructions can be logically encapsulated in a software development kit (SDK) which includes a user-interactive DDoS attack mitigation scheme, a communication module for facilitating the data communication with the central processing server, and a set of application programming interfaces (APIs) to facilitate the invocation calls from and data exchanges with the mobile app integrating with the DDoS attack mitigation system.

In accordance with another aspect of the present invention, a DDoS attack mitigation process is provided, comprising: receiving, by the DDoS attack mitigation SDK through an mobile app's invocation call to one or more of its APIs, a request for a service or access to a resource, wherein the service or resource being hosted in a second computer processor; forwarding, by the DDoS attack mitigation SDK through its communication module, the request to the DDoS attack mitigation central processing server; responding, by the DDoS attack mitigation central processing server, with one or more secure cookies or tokens, wherein the secure cookies or tokens are strings of data generated by the DDoS attack mitigation central processing server particularly for the current session; sending again, by the DDoS attack mitigation SDK through its communication module, the request along with the received secure cookies or tokens to the DDoS attack mitigation central processing server; temporary storing, by the DDoS attack mitigation central processing server, the request; determining, by the DDoS attack mitigation central processing server, whether to issue a DDoS attack mitigation challenge; if it is determined to issue a DDoS attack mitigation challenge, generating, by the DDoS attack mitigation central processing server, a new DDoS attack mitigation challenge; sending, by the DDoS attack mitigation central processing server, to the DDoS attack mitigation SDK the DDoS attack mitigation challenge; receiving, by the DDoS attack mitigation SDK, the DDoS attack mitigation challenge; displaying, by the DDoS attack mitigation SDK via the mobile app, a user-interactive DDoS attack mitigation scheme presenting the DDoS attack mitigation challenge; receiving, by the DDoS attack mitigation SDK, the user's authenticating action to the DDoS attack mitigation challenge on the user-interactive DDoS attack mitigation scheme; sending, by the DDoS attack mitigation SDK, the user's authenticating action response to the DDoS attack mitigation central processing server; receiving, by the DDoS attack mitigation central processing server, the user's authenticating action response; authenticating, by the DDoS attack mitigation central processing server, the user's authenticating action; if authenticated, forwarding, by the DDoS attack mitigation central processing server, the request for a service or resource to the second processing server hosting the service or resource requested; if not authenticated, responding, by the DDoS attack mitigation central processing server, a notification data to the DDoS attack mitigation SDK to block the request, which in turn displaying to the user that the authentication of the DDoS attack mitigation challenge has failed and that the request is blocked.

In accordance to various embodiments, the presently claimed DDoS attack mitigation system and process can be integrated with the DDoS attack mitigation system and process disclosed in the U.S. patent application Ser. No. 14/565,440. For instance, the determination of whether to issue a DDoS attack mitigation challenge can adopt the corresponding the process steps disclosed in the U.S. patent application Ser. No. 14/565,440; and the presently claimed DDoS attack mitigation system, including the DDoS attack mitigation SDK, can be a component of the system disclosed in the U.S. patent application Ser. No. 14/565,440.

### BRIEF DESCRIPTION OF THE DRAWINGS

Embodiments of the invention are described in more detail hereinafter with reference to the drawings, in which

FIG. 1 shows a block diagram illustrating an exemplary embodiment of a computing environment that the presently claimed DDoS mitigation system is applicable;

FIG. 2 shows a logical diagram illustrating the logical functional modules of the DDoS mitigation system in accordance to one embodiment of the present invention;

FIG. 3 shows a screen capture of a user-interactive DDoS attack mitigation scheme in accordance to one embodiment of the present invention; and

FIG. 4 shows a logical diagram illustrating the process steps and data flow of the DDoS mitigation process in accordance to one embodiment of the present invention.

### DETAILED DESCRIPTION

In the following description, methods and systems for protecting against DDoS attacks and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

System:

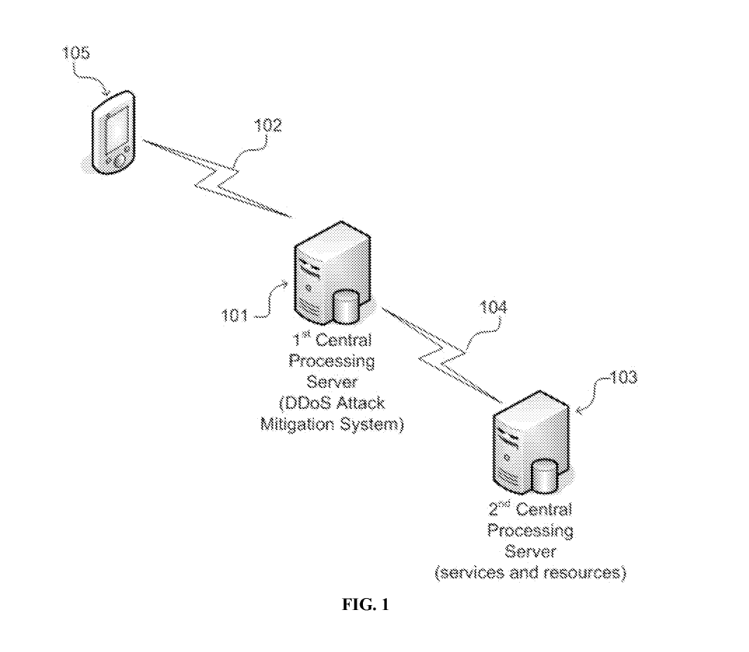

Referring to FIG. 1. In accordance with various embodiments, the presently claimed invention is applicable in a computing environment comprising: a first central processing server (or a first cluster of multiple processing servers) 101 accessible through a first communication network 102, which can be the Internet, a telecommunication network, or any network supporting the TCP/IP protocol; a second central processing server (or a second cluster of multiple processing servers) 103 connected to the first central processing server 101 through a second communication network 104, wherein the second communication network 104 can be the same as the first communication network 102; a plurality of client users using various mobile communication devices 105 running mobile apps to access the services and/or resources (e.g. an URL) provided by the second central processing server 103.

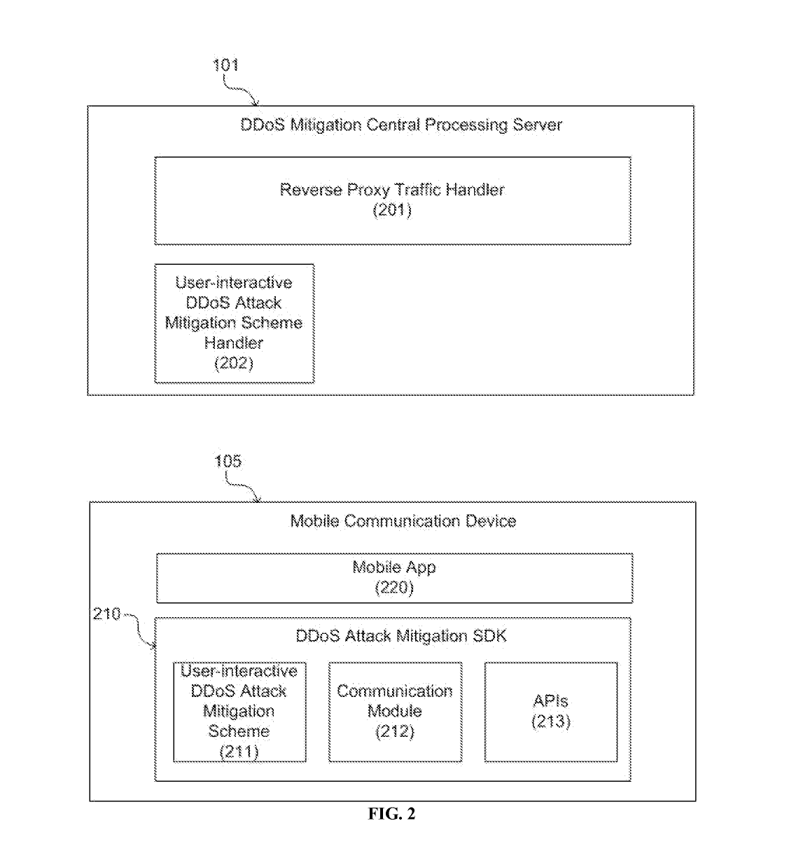

Referring to FIG. 2. In accordance with one aspect, the first central processing server (or cluster of multiple processing servers) 101 is configured to execute server-side machine instructions implementing one part of the presently claimed DDoS attack mitigation system. The server-side machine instructions can be logically grouped into functional modules. The functional modules are: the reverse proxy traffic handler 201, and the user-interactive DDoS attack mitigation scheme handler 202 for issuing DDoS attack mitigation challenges and authenticating the challenge responses.

Still referring to FIG. 2. In accordance with another aspect, each of the mobile communication devices 105 is configured to execute device-side machine instructions implementing another part of the presently claimed DDoS attack mitigation system. The device-side machine instructions can be logically encapsulated in a SDK 210 which includes a user-interactive DDoS attack mitigation scheme 211, a communication module 212 for facilitating the data communication with the first central processing server 101, and a set of APIs 213 to facilitate the invocation from and data exchanges with the mobile app 220 integrating the DDoS attack mitigation system.

The reverse proxy traffic handler 201 acts as an intermediary between the client users' mobile communication devices 105, and the services and/or resources provided by the second central processing server (or cluster of multiple processing servers) 103 in their data communication paths. The reverse proxy traffic handler 201 includes the functionalities of a reverse proxy server as commonly known in the art, and it is implementable by any means known by an ordinarily skilled person in the art. The reverse proxy traffic handler 201 is to intercept the data traffic to the second central processing server (or cluster of multiple processing servers) 103 such as requests for services and/or resources originated from a client user's mobile communication device, forward the requests to the second central processing server (or cluster of multiple processing servers) 103 if deemed safe and return the responds from the second central processing server (or cluster of multiple processing servers) 103 to the request data-originating client users' mobile communication device. Otherwise if the data traffic is deemed unsafe, a mitigation is triggered and the reverse proxy traffic handler 201 responds with a DDoS attack mitigation challenge to the data-originating client users' mobile communication device.

In one embodiment, the reverse proxy traffic handler 201 is the reverse proxy traffic handler as disclosed in the U.S. patent application Ser. No. 14/565,440.

The user-interactive DDoS attack mitigation scheme handler 202 is used to generate DDoS attack mitigation challenges. Each DDoS attack mitigation challenge conforms to a user-interactive DDoS attack mitigation scheme. The user-interactive DDoS attack mitigation scheme allows permutations of DDoS attack mitigation challenge, thus each DDoS attack mitigation challenge generated can be the same or different from the previously generated DDoS attack mitigation challenge. The user-interactive DDoS attack mitigation scheme handler 202 is also responsible for authenticating the client users' authenticating action to the DDoS attack mitigation challenges.

Each of the functional modules: the reverse proxy traffic handler 201, and the user-interactive DDoS attack mitigation scheme handler 202 can be implemented and executed in a single physical computer server of the first central processing server 101, separately or in any combination in multiple physical computer servers of the cluster of multiple first central processing server 101.

The DDoS attack mitigation SDK 210 includes the user-interactive DDoS attack mitigation scheme 211, the communication module 212 for facilitating the data communication with the first central processing server 101, and the set of APIs 213 to facilitate the invocation calls from and data exchanges with the mobile app 220 integrating with the DDoS attack mitigation system. The user-interactive DDoS attack mitigation scheme 211 includes at least a graphical user interface (GUI) to be displayed on the screen of a mobile communication device and accepts user's input such as touch input on a touch screen, input from a pointing device, or key presses/strokes on a keyboard. The user-interactive DDoS attack mitigation scheme 211 is invoked and its GUI is displayed when the user-interactive DDoS attack mitigation scheme handler 202 running in the first central processing server 101 issues a DDoS attack mitigation challenge and communicates as such with the DDoS attack mitigation SDK 210. The APIs 213 provide a programming entry point for the mobile app 220 to make requests for services and/or resources to the second central processing server 103. Alternatively, the DDoS attack mitigation SDK 210 can be installed and configured as a background process in a mobile communication device that intercepts the requests for services and/or resources to the second central processing server 103. The communication module 212 then redirects the requests to the first central processing server 101 for processing.

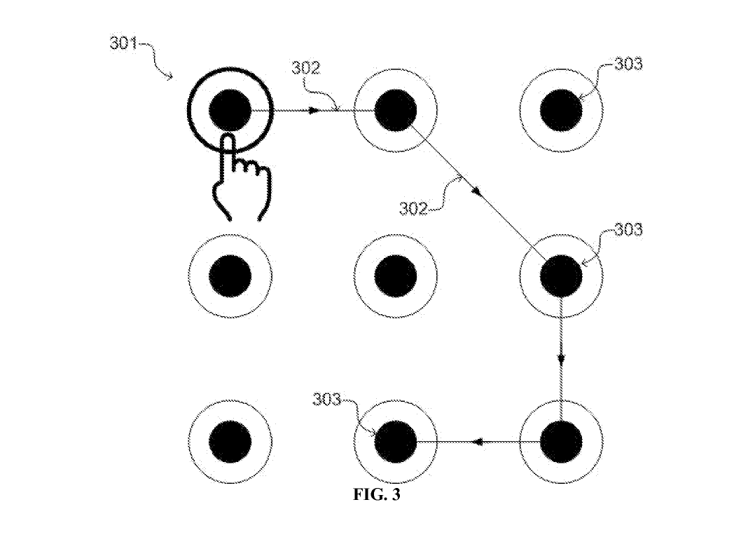

Referring to FIG. 3. In accordance with one embodiment, the user-interactive DDoS attack mitigation scheme 211 is a gesture-based CAPTCHA with a GUI suitable to be displayed on a touch screen of a mobile communication device and accepts touch input on the touch screen from a user. The user-interactive DDoS attack mitigation scheme 211 essentially is a grid 301 with finger touch movement path or pattern indicator 302 connecting two or more vertices 303. In one exemplary embodiment, the grid is three by three in size. Other dimensions can be adopted without deviating from the concept of the present invention. Each finger touch movement path or pattern represents a DDoS attack mitigation challenge and different finger touch movement paths or patterns are randomly generated during runtime by the user-interactive DDoS attack mitigation scheme handler 202 running in the first central processing server 101. The user is successfully authenticated if she/he provides the touch input on the touch screen following exactly the finger touch movement path or pattern without interruption.

DDoS Mitigation Process:

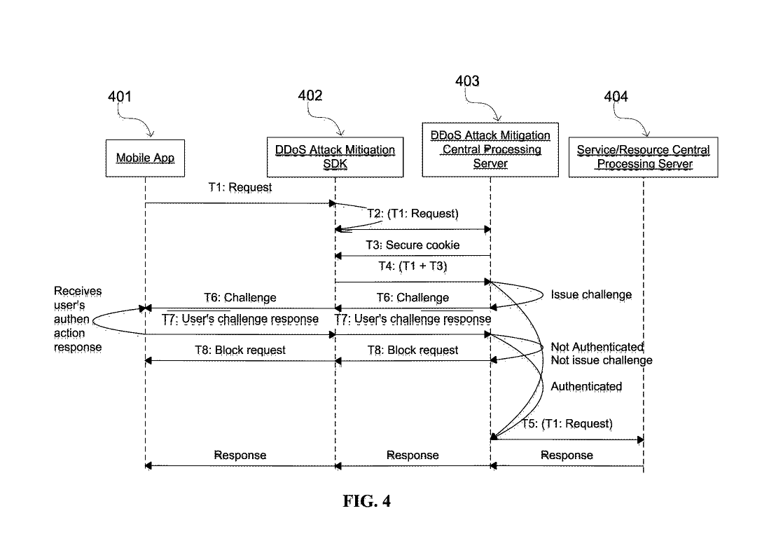

Referring to FIG. 4. In accordance with various embodiments, the presently claimed invention includes a DDoS mitigation process executed by a DDoS mitigation system, the DDoS mitigation process comprising the following process steps:

1.) A client user's mobile communication device running a mobile app 401 requesting for a service or access to a resource in turn generating a request T1 to a service or resource hosted in the second central processing server 404.

2.) The DDoS attack mitigation SDK 402 receives the request T1 by the mobile app 401 invoking its APIs; or alternatively, the DDoS attack mitigation SDK 402 intercepts the request as the mobile app 401 initiates the communication protocol for the request.

3.) The DDoS attack mitigation SDK 402, through its communication module, forwards the request T1 to the first central processing server 403 in a data message T2.

4.) The first central processing server 403 responds with one or more secure cookies or tokens in a data message T3, wherein the secure cookies or tokens are strings of data generated by the first central processing server 403 particularly for the current session.

5.) The DDoS attack mitigation SDK 402 receives the response with the secure cookies or tokens T3 and sends the request T1 again along with the secure cookies or tokens to the first central processing server 403 in a data message T4.

6.) The first central processing server 403 receives the request with the secure cookies or tokens T4 and temporary stores the request T1.

7.) The first central processing server 403 determines whether to issue a DDoS attack mitigation challenge.

8.) If it is determined not to issue a DDoS attack mitigation challenge, the first central processing server 403 forwards the temporary stored the request T1 to the second central processing server 404 in a data message T5.

9.) Otherwise, if it is determined to issue a DDoS attack mitigation challenge, the first central processing server 403 generates and sends to the DDoS attack mitigation SDK 402 a new DDoS attack mitigation challenge in a data message T6.

10.) The DDoS attack mitigation SDK 402 receives the DDoS attack mitigation challenge T6.

11.) The DDoS attack mitigation SDK 402 causes the mobile communication device to display its user-interactive DDoS attack mitigation scheme presenting the DDoS attack mitigation challenge.

12.) The user responds to the DDoS attack mitigation challenge by performing an authenticating action.

13.) The DDoS attack mitigation SDK 402 receives the user's authenticating action and sends it to the first central processing server 403 in a data message T7.

14.) The first central processing server 403 receives and authenticates the user's authenticating action T7.

15.) If authenticated, the first central processing server 403 forwards the stored request T1 to the second processing server 404 in a data message T5.

16.) Otherwise, if not authenticated, the first central processing server 403 responds with a notification data message T8 to the DDoS attack mitigation SDK 402 to block the request T1, which in turn displaying to the user that the authentication of the DDoS attack mitigation challenge has failed and that the request T1 is blocked.

In accordance to various embodiments, the presently claimed DDoS attack mitigation system and process can be integrated with the DDoS attack mitigation system and process disclosed in the U.S. patent application Ser. No. 14/565,440. For instance, the determination of whether to issue a DDoS attack mitigation challenge can adopt corresponding the process step disclosed in the U.S. patent application Ser. No. 14/565,440; and the presently claimed DDoS attack mitigation system, including the DDoS attack mitigation SDK, can be a component of the system disclosed in the U.S. patent application Ser. No. 14/565,440.

The embodiments disclosed herein may be implemented using general purpose or specialized computing devices, mobile communication devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, mobile communication devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Exemplary embodiments of mobile communication devices include, but are not limited to, mobile telephones, mobile telephones with personal computer like capability (commonly referred to as “smartphones”), electronic personal digital assistants (PDAs), portable computers with wired or wireless wide-area-network and/or telecommunication capability such as tablet personal computers and “netbook” personal computers.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for mitigating distributed denial of service (DDoS) attacks, comprising:
receiving, by a DDoS attack mitigation module from an mobile application, a request for a service or access to a resource, wherein the service or resource being hosted in a first computer processor, wherein the DDoS attack mitigation module and the mobile application are being executed by one or more processors in a mobile communication device;
forwarding, by the DDoS attack mitigation module, the request to a second central processing server;
determining, by the second central processing server, whether to issue a DDoS attack mitigation challenge;
if it is determined to issue a DDoS attack mitigation challenge, generating, by the second central processing server, a new DDoS attack mitigation challenge;
receiving, by the DDoS attack mitigation module, the DDoS attack mitigation challenge;
displaying, by the mobile communication device running the DDoS attack mitigation module, a user-interactive DDoS attack mitigation scheme presenting the DDoS attack mitigation challenge;
receiving, by the mobile communication device running the DDoS attack mitigation module, a user's authenticating action response to the new DDoS attack mitigation challenge on the user-interactive DDoS attack mitigation scheme;
sending, by the DDoS attack mitigation module, the user's authenticating action response to the second central processing server;
receiving, by the second central processing server, the user's authenticating action response;
authenticating, by the second central processing server, the user's authenticating action response;
if authenticated, forwarding, by the second central processing server, the request for service or access to resource to the first central processing server; and
else if not authenticated, responding, by the second central processing server, a notification data to the DDoS attack mitigation module to block the request, which in turn causing the mobile communication device to notify the user that the authentication of the DDoS attack mitigation challenge has failed and that the request is blocked.

2. The method of claim 1, further comprising:
after forwarding, by the DDoS attack mitigation module, the request to the second central processing server,
responding, by the second central processing server with one or more secure cookies or tokens; and
resending, by the DDoS attack mitigation module, the request with the secure cookies or tokens to the second central processing server.

3. The method of claim 1,
wherein the user-interactive DDoS attack mitigation scheme being a grid with a finger touch movement path or pattern indicator connecting two or more vertices; and
wherein the user authentication action being providing a touch input on the mobile communication device's touch screen following exactly the finger touch movement path or pattern without interruption.

4. The method of claim 3, wherein the grid is three by three in size.
